(19) United States
(12) Patent Application Publication
(10) Pub. No.: US 2015/0232489 A1
(43) Pub. Date: Aug. 20, 2015

(54) Functionalisable Polysilylated Organosilane Precursors

(71) Applicants: CENTRE NATIONAL DE LA RECHERCHE SCIENTIFIQUE (C.N.R.S), Paris (FR); ECOLE NATIONALE SUPERIEURE DE CHIMIE DE MONTPELLIER, Montpellier (FR); UNIVERSITE MONTPELLIER 2, SCIENCES ET TECHNIQUES, Montpellier (FR)

(72) Inventors: Michel Wong Chi Man, Vendargues (FR); Xavier Cattoen, Montpellier (FR); Nirmalya Moitra, Kolkata (IN); Kristyna Burglova, Prerov (CZ); Jana Hodacova, Prague (CZ)

(73) Assignees: CENTRE NATIONAL DE LA RECHERCHE SCIENTIFIQUE (C.N.R.S.), Paris (FR); ECOLE NATIONALE SUPERIEURE DE CHIMIE DE DE MONTPEILLIER, Montpellier (FR); UNIVERSITE MONTPELLIER 2, SCIENCES ET TECHNIQUES, Montpellier (FR)

(21) Appl. No.: 14/412,878

(22) PCT Filed: Jul. 8, 2013
(86) PCT No.: PCT/EP2013/064376

§ 371 Date: Jan. 5, 2015

(30) Foreign Application Priority Data
Jul. 6, 2012 (FR) 1256545

(51) Int. Cl. C07F 7/18

(52) U.S. Cl. CPC C07F 7/1836; C07F 7/184

(57) ABSTRACT

The present invention concerns a funtionalisable polysilylated organosilane precursors with formula (I): in which: Z¹ represents a moiety with formula (a) and Z² represents a moiety with formula (b) Z¹ and Z² simultaneously represent a moiety chosen from the moieties R⁷R⁸Si(OH), R⁹Si(OH)₂, Si(OH)₃, R⁷R⁸SiO_{1/2}, R⁹SiO or Si0_{3/2}; U represents a moiety chosen from the moieties with formulas (U¹), (U²), (U³), (U⁴), (U⁵), (U⁶), (U⁷), (U⁸).

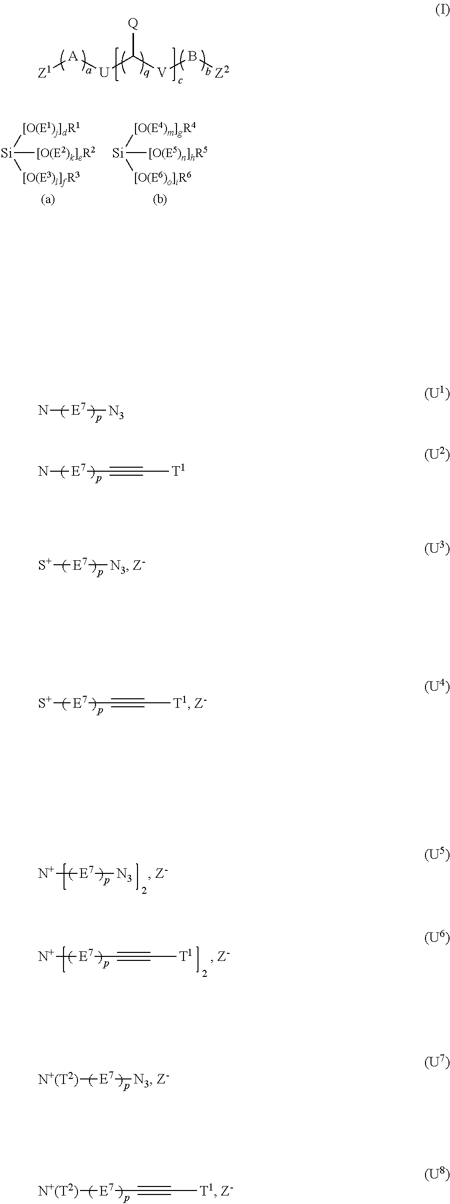

The present invention relates to a functionalizable organosilane polysilylated precursor and to its preparation method.

The invention also relates to a functionalized organosilicon material derived from this precursor.

Functionalizable organosilane precursors have a major benefit in many fields because they allow the manufacturing of mono- or poly-functionalized organosilicon hybrid materials, which may appear as a powder, a coating or a polymer or may be integrated into a silicone matrix.

They also allow the manufacturing of products appearing as functionalized particles, notably functionalized nanoparticles, for example with an active remainder, which may notably be salted out in a controlled way under the action of one or several parameters.

The reaction between organosilane precursors comprising a nitride group and a functional compound comprising an alkyne group has been described, giving the possibility of thus obtaining functionalized organosilane compounds (Moitra et al., Chem. Commun., 2010, 46, 8416-8418: Bürglova et al., J. Org. Chem., 2011, 76, 7326-7333).

However, the described precursors are monosilylated precursors and the described reaction only gives the possibility of resulting in organosilane compounds comprising in majority simple functionalities, such as amine, alcohol, thiol, halide, alkyl or phenyl.

Moreover organosilane precursors in which a reactive group is bound to two silylated chains have been described (Shea et al., Functional Hybrid Materials, 2004, 50-85). However, the fact that the reactive group is directly bound to the silylated chains reduces access to other reactive groups and thus limits the possibilities of a subsequent reaction.

Thus, a first object of the invention is to provide organosilane precursors with which it is possible to obtain functionalized polysilylated organosilane compounds which get rid of the problems of the state of the art and which provide a solution to all or part of the problems of the state of the art.

Another object of the invention is to propose polysilylated organosilane precursors for which the preparation method is easy to apply and has a high yield.

Another object of the invention is to propose polysilylated organosilanes giving the possibility of preparing post-functionalizable organosilicas which may appear in various forms, such as monolithic nanoparticle films or further powders

An object of the present invention is a compound of formula (I)

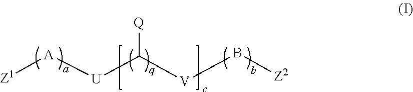

wherein:
Z¹ represents a group of formula

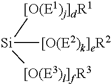

and Z² represents a group of formula

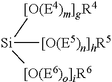

Z¹ and Z² simultaneously represent a group selected from the groups R⁷R⁸Si(OH), R⁹Si(OH)₂, Si(OH)₃, R⁷R⁸SiO_{1/2}, R⁹SiO or SiO_{3/2}:
U represents a group selected from the groups of formulae

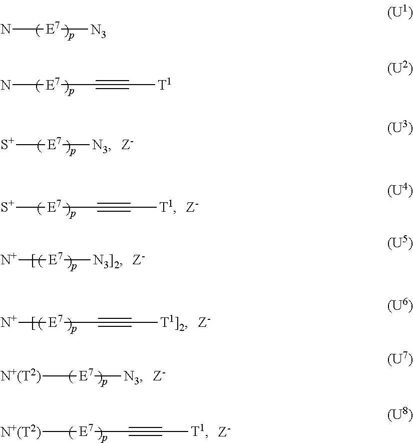

R¹, R², R³, R⁴, R⁵ and R⁶, either identical or different, represent a hydrogen atom, a C₁-C₆-alkyl group, an aryl group, a C₁-C₆-alkoxy group, a C₃-C₈-alkylene-alkenyl group:
E¹, E², E³, E⁴, E⁵ and E⁶, either identical or different, represent a C₁-C₆-alkylene group, C(O), C═CH₂, an imino-C₁-C₆-alkyl group, a group (C₁-C₆-alkyl)C═N—:
d, e, f, g, h, i, either identical or different, represent 0, 1, 2, 3, 4, 5, 6:
j, k, l, m, n, o, either identical or different, represent 0, 1, 2, 3:
A, either identical or different, represents a —CR¹⁰R¹¹ group or a group selected from the groups of formulae

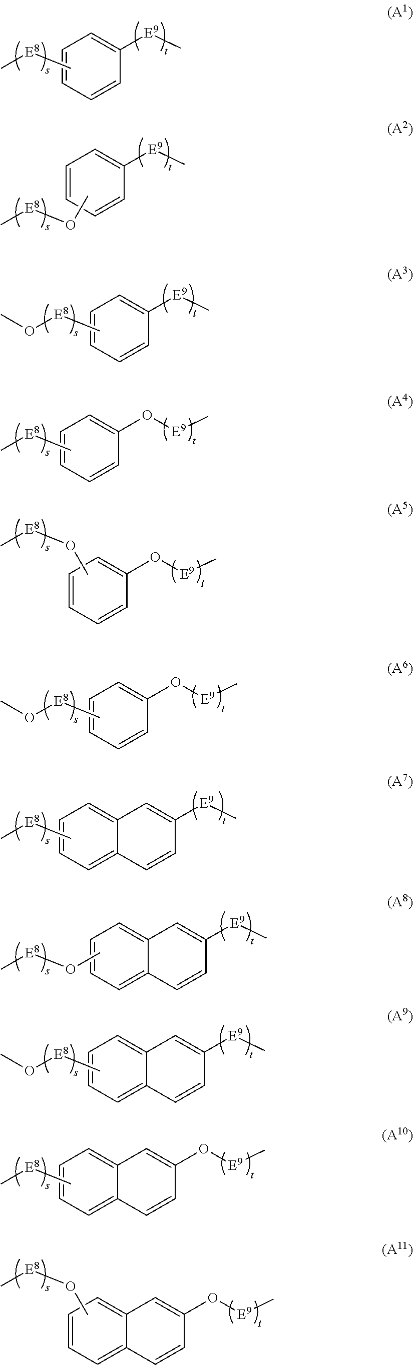

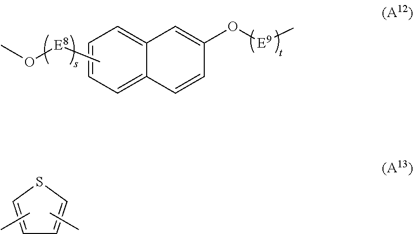

a represents 1, 2, 3, 4, 5, 6, 7, 8, 9, 10, 11 or 12:
B, either identical or different, represents a group —CR¹²R¹³ or a group selected from the groups of formulae

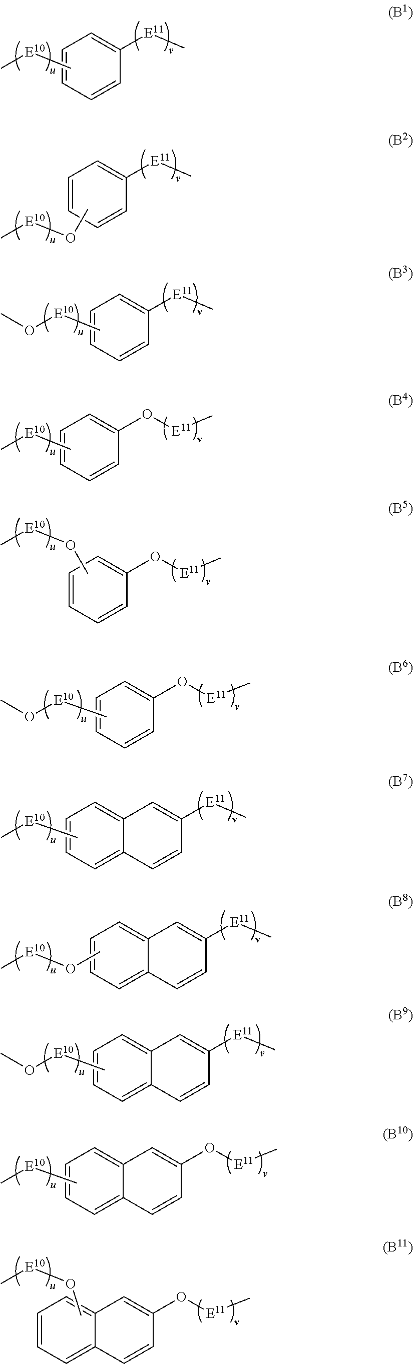

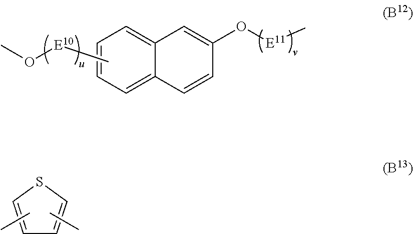

b represents 1, 2, 3, 4, 5, 6, 7, 8, 9, 10, 11 or 12:
V, either identical or different, represents independently a group selected from the groups of formulae

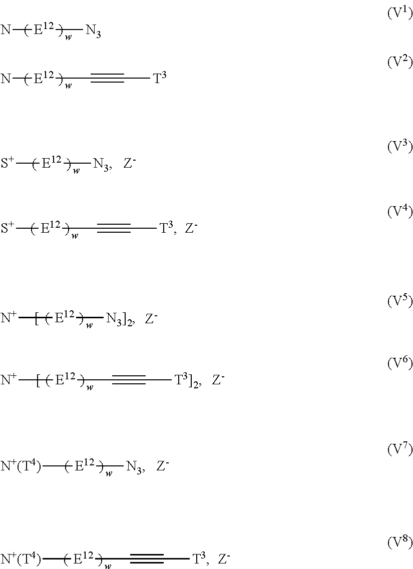

c represents 0, 1, 2 or 3:
Q, either identical or different, represents a hydrogen atom, a C₁-C₁₀ alkyl group, a C₁-C₁₀ alkoxy group, a C₃-C₁₀ cycloalkyl group, an aryl group: at least 2 groups Q and the carbon atoms to which they are bound form a carbocycle with 5, 6, 7, 8, 9 or 10 carbon atoms, substituted or non-substituted, aromatic or non-aromatic, saturated, partly or totally unsaturated, fused or non-fused:
q represents 0, 1, 2, 3, 4, 5, 6, 7, 8, 9, 10, 11 or 12:
E⁷, E⁸, E⁹, E¹⁰, E¹¹ and E¹² either identical or different, represent a group CR¹⁴R¹⁵, a group OCR¹⁶R¹⁷:
s, t, u and v, either identical or different, represent 0, 1, 2, 3, 4, 5, 6:
T² and T³, either identical or different, represent a hydrogen atom, a group —Si(R¹⁸)(R¹⁹)(R²⁰), a group —C(R²¹)(R²²)(OH):
T² and T⁴, either identical or different, represent a group (E¹³)ₓSi(R²³)(R²⁴)(R²⁵):
E¹³ represents a group —CR²⁶R²⁷:
R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶ and R²⁷ either identical or different, represent a hydrogen atom, a C₁-C₆-alkyl group, a C₁-C₆-alkoxy group, a C₃-C₈-alkylene-alkenyl group, an aryl group, an aryloxy group:
p, w and x either identical or different, represent 1, 2, 3, 4, 5, 6, 7, 8, 9, 10, 11 or 12:
Z⁻ represents an anion selected from halides, BF₄⁻, B(Ph)₄⁻, CO₃²⁻, R²⁸CO₂⁻, R²⁹SO₃⁻, SO₄²⁻, PO₄³⁻, HPO₃²⁻, NO₃⁻;
R²⁸ represents a C₁-C₃ alkyl group or an aryl group, preferably a methyl group or a phenyl group:
R²⁹ represents a C₁-C₃ alkyl group, preferably methyl, an aryl group, preferably phenyl or a group —CF₃:
   as well as an enantiomer, an isomer or a diastereoisomer of this compound.

According to the invention, in the groups of formulae A⁷ to A¹² and B⁷ to B¹², the substituent groups may be present on one of the aryl groups forming the naphthyl radical or on each of the aryl groups forming the naphthyl radical.

According to the invention, in the groups U¹, U², U⁵, U⁶, U⁷, U⁸, V¹, V², V⁵, V⁶, V⁷ and V⁸, the nitrogen atom ensures the bond with the remainder of the compound of formula (I).

According to the invention, in the groups U³, U⁴, U⁵, V³ and V⁴, the sulfur atom ensures the bond with the remainder of the compound of formula (I).

The compound according to the invention may be a compound of formula (II)

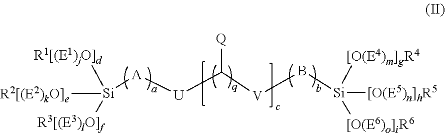

The definitions of R¹, R², R³, R⁴, R⁵, R⁶, E¹, E², E³, E⁴, E⁵, E⁶, A, U, Q, V, B, a, b, c, d, e, f, g, h, i, j, k, l, m, n, o and q for the compound of formula (I) according to the invention apply to the compound of formula (II).

The invention also provides a compound of formulae (IIa), (IIb) or (IIc)

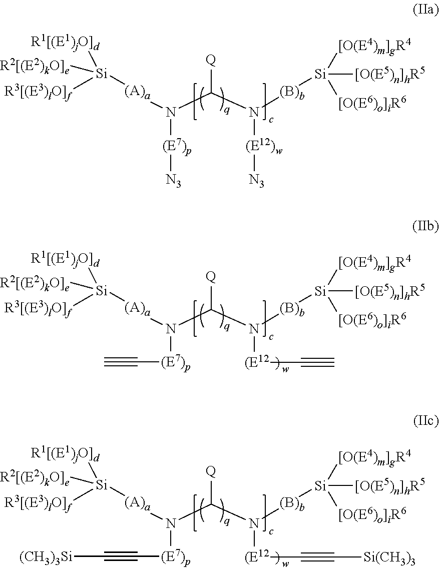

The definitions of R¹, R², R³, R⁴, R⁵, R⁶, E¹, E², E³, E⁴, E⁵, E⁶, E⁷, E¹², A, B, Q, a, b, c, d, e, f, g, h, i, j, k, l, m, n, o, p, q and w for the compound (I) according to the invention apply to the compounds of formula (IIa), (II) and (IIc).

The invention also provides a compound of formulae (IId) or (IIe)

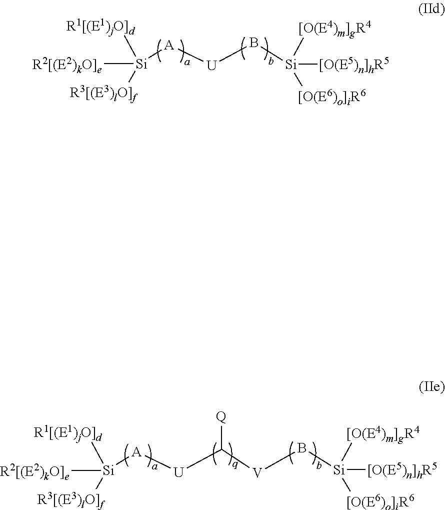

The definitions of R¹, R², R³, R⁴, R⁵, R⁶, E¹, E², E³, E⁴, E⁵, E⁶, A, B, Q, U, V, a, b, d, e, f, g, h, i, j, k, l, m, n, o and q for the compound of formula (I) according to the invention apply to the compounds of formula (IId) and (IIe).

The invention also provides a compound of formulae (IIf), (IIg), (IIh), (IIi), (IIj) or (IIk)

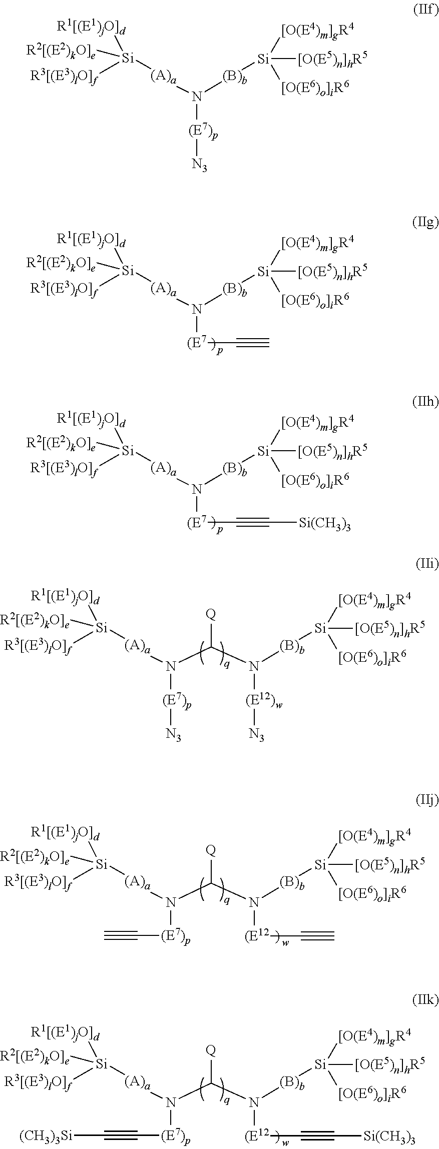

The definitions of R¹, R², R³, R⁴, R⁵, R⁶, E¹, E², E³, E⁴, E⁵, E⁶, E⁷, E¹², A, B, Q, a, b, d, e, f, g, h, i, j, k, l, m, n, o, p, q and w for the compound of formula (I) according to the invention apply to the compounds of formula (IIf), (IIg), (IIh), (IIi), (IIj) and (IIk).

Preferably, the compound may be a compound of formula (IIi), (IIj) or (IIk).

According to the invention, the compound may be a compound of formula (III), (IV) or (V)

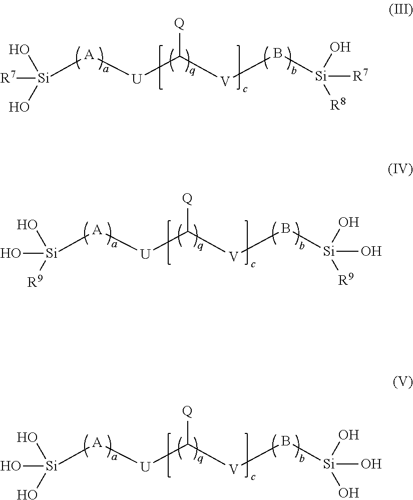

The definitions of R⁷, R⁸, R⁹, A, U, Q, V, B, a, b, c and q for the compound of formula (I) according to the invention apply to the compounds of formula (III), (IV) and (V).

The invention also provides a compound of formulae (VI), (VII) or (VIII) respectively obtained by polycondensation of a compound of formula (III), (IV) or (V) according to the invention

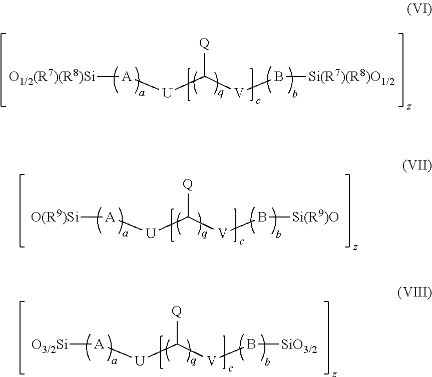

The definitions of R⁷, R⁸, R⁹, A, U, Q, V, B, a, b, c and q for the compound of formula (I) according to the invention apply to the compounds of formula (VI), (VII) and (VIII).

According to the invention, z may represent an integer ranging from 2 to 2,000,000.

According to the invention, the compounds of formulae (VI), (VII) or (VIII) are units present within polymeric structures.

Thus, the compounds of formula (VI), (VII) or (VIII) represent monomers or oligomers for preparing other oligomers or polymers.

The invention provides an exemplary compound of formula (VIII):

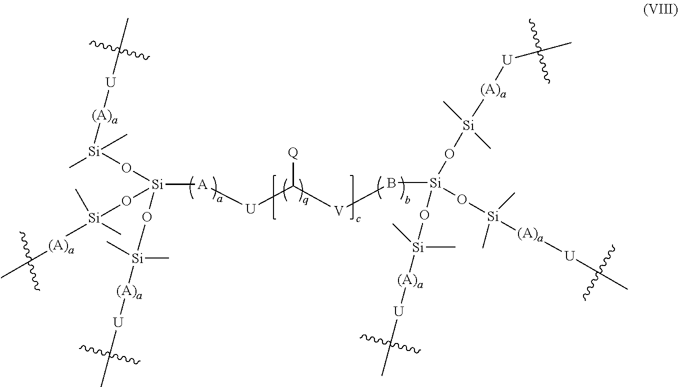

The definitions of A, U, Q, V, B, a, b, c and q for the compound of formula (I) apply to the compound of formula (VIII).

Advantageously, for the compounds according to the invention:
A and B represent a group —(CH₂)—: or
Q represents a hydrogen atom: or
R¹, R², R³, R⁴, R⁵ and R⁶ represent independently a methyl or ethyl group; or
a represents 1, 2 or 3: or
b represents 1, 2 or 3: or
q represents 0, 1, 2, 3 or 4: or
d, e, f, g, h and i, either identical or different, represent 0 or 1: or
j, k, l, m, n and o represent 0: or
R⁷ represents a methyl, ethyl, phenyl group: or
R⁸ represents a methyl, ethyl, phenyl group: or
R⁹ represents a methyl, ethyl, phenyl group: or
R²⁸ represents a methyl group or a phenyl group; or
R²⁹ represents a methyl group, a phenyl group or a group —CF₃.

Advantageously, the compound according to the invention is a compound of formulae (II), (IIa), (IIb), (IIc), (IId), (IIe), (IIf), (IIg), (IIh), (Iii), (IIj) or (IIk) wherein:
A and B represent a group —(CH₂)—:
Q represents a hydrogen atom:
R¹, R², R³, R⁴, R⁵ and R⁶ represent independently a methyl or ethyl group;
a represents 1, 2 or 3:
b represents 1, 2 or 3:
q represents 0, 1, 2, 3 or 4:
d, e, f, g, h and i, either identical or different, represent 0 or 1:
j, k, l, m, n and o represent 0.

Also advantageously, the compound according to the invention is a compound of formulae (II), (IIa), (IIb), (IIc), (IId), (IIe), (IIf), (IIg), (IIh), (Iii), (IIj) or (IIk) wherein R¹, R², R³, R⁴, R⁵ and R⁶ represent independently an alkoxy group, preferably methoxy or ethoxy.

Also advantageously, when R¹, R², R³, R⁴, R⁵ and R⁶ represent independently an alkoxy group, j, k, l, m, n and o do not represent 0.

As an example of a compound of formula (IIf) according to the invention, mention may be made of the compound of formula (IIf-1)

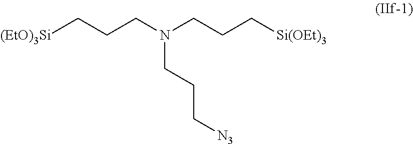

As examples of compounds of formula (IIg) according to the invention, mention may be made of the compounds of formulae (IIg-1) or (IIg-2)

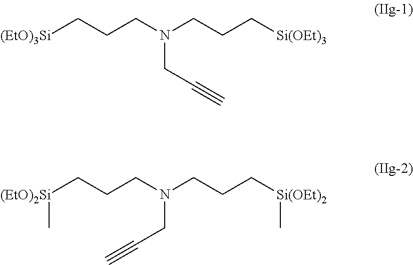

As an example of a compound of formula (IIh) according to the invention, mention may be made of the compound of formula (IIh-1)

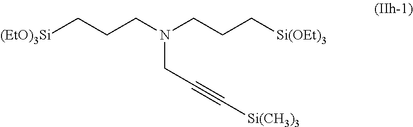

As an example of a compound of formula (IIi) according to the invention, mention may be of the compound of formula (IIi-1)

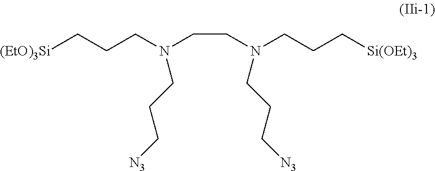

As examples of compounds of formula (IIj) according to the invention, mention may be made of the compounds of formulae (IIj-1), (IIj-2) or (IIj-3):

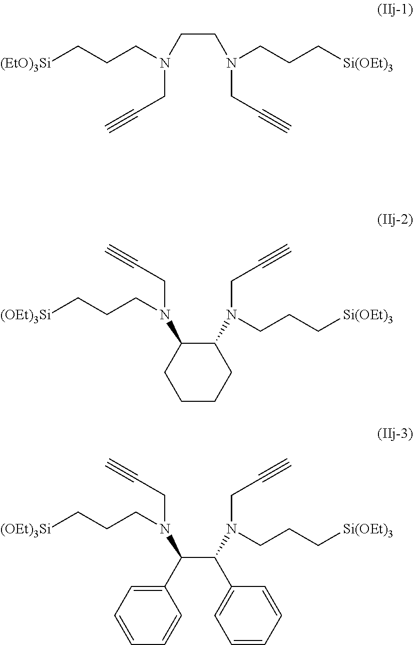

Advantageously, the compound according to the invention is a compound of formula (III), (IV), (V), (VI), (VII) or (VIII) wherein:
A and B represent a group —(CH₂)—:
Q represents a hydrogen atom:
a represents 3, 4, 5, or 6:
b represents 3, 4, 5, or 6:
q represents 0, 1, 2, 3 or 4:
d, e, f, g, h and i, either identical or different, represent 0 or 1:
j, k, l, m, n, and o represent 0:
R⁷ represents a methyl, ethyl, phenyl group:
R⁸ represents a methyl, ethyl, phenyl group:
R⁹ represents a methyl, ethyl, phenyl group.

The object of the invention is also a method for preparing a compound of formula (IIa)

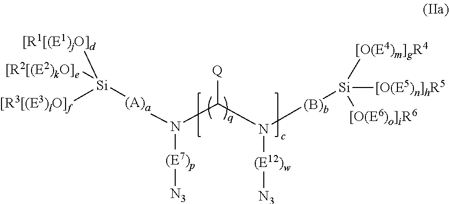

wherein:
E⁷ and E¹² are identical,
p and w are identical,
the definitions and preferred characteristics of R¹, R², R³, R⁴, R⁵, R⁶, E¹, E², E³, E⁴, E⁵, E⁶, E⁷, E¹², A, B, Q, a, b, c, d, e, f, g, h, i, j, k, l, m, n, o, p, q and w for the compound (I) according to the invention apply to the compounds of formula (IIa):
   by reaction between a compound of formula (IX)

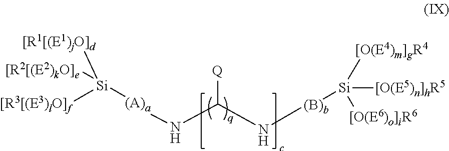

wherein the definitions and preferred characteristics of R¹, R², R³, R⁴, R⁵, R⁶, E¹, E², E³, E⁴, E⁵, E⁶, A, B, Q, a, b, c, d, e, f, g, h, i, j, k, l, m, n and o and q for the compound (I) according to the invention apply to the compounds of formula (IX):
and a compound of formula (X)

N₃E⁷ₚI (X)

According to the invention, the reaction may be conducted between a compound equivalent of formula (IX) and (c+1) equivalents of a compound of formula (X) in the presence of 2×(c+1) equivalents of potassium carbonate.

According to the invention, the definition of c is identical with the definition of c for the compound of formula (IX) and may thus represent 0, 1, 2 or 3.

According to the invention, the reaction between the compound of formula (IX) and the compound of formula (X) occurs in a solution in the presence of potassium carbonate.

According to the invention, the content of compound of formula (IX) in the solution may range from 0.001 to 1 mol/L, preferably from 0.1 to 0.2 mol/L.

According to the invention, the reaction may be conducted in the presence of a solvent, preferably acetonitrile.

According to the invention, the reaction may be conducted at 85° C. and under an inert atmosphere for a period ranging from 15 to 24 h.

The object of the invention is also a method for preparing a compound of formula (IIb)

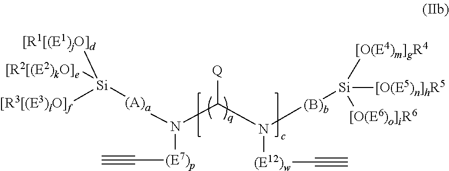

wherein:
E⁷ and E¹² are identical,
p and w are identical,
the definitions and preferred characteristics of R¹, R², R³, R⁴, R⁵, R⁶, E¹, E², E³, E⁴, E⁵, E⁶, E⁷, E¹², A, B, Q, a, b, c, d, e, f, g, h, i, j, k, l, m, n, o, p, q and w for the compound (I) according to the invention apply to the compounds of formula (IIb):
   by reaction between a compound of formula (XI)

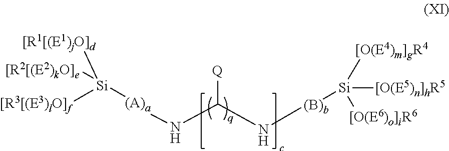

wherein the definitions and preferred characteristics of R¹, R², R³, R⁴, R⁵, R⁶, E¹, E², E³, E⁴, E⁵, E⁶, A, B, Q, a, b, c, d, e, f, g, h, i, j, k, l, m, n and o and q for the compound (I) according to the invention apply to the compounds of formula (XI):
and a compound of formula (XII)

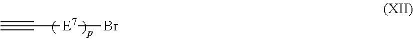

According to the invention, the reaction may be conducted between an equivalent of a compound of formula (XI) and (c+1) equivalents of compound of formula (XII) in the presence of 2×(c+1) equivalents of calcium hydride.

According to the invention, the definition of c is identical with the definition of c for the compound of formula (XI) and may thus represent 0, 1, 2 or 3.

According to the invention, the reaction between the compound of formula (XI) and the compound of formula (XII) occurs in a solution in the presence of calcium hydride.

According to the invention, the content of a compound of formula (XI) in the solution may range from 0.001 to 1 mol/L, preferably from 0.1 to 0.5 mol/L.

According to the invention, the reaction may be carried out in the presence of a solvent, preferably tetrahydrofurane.

According to the invention, the reaction may be carried out at a temperature ranging from 15 to 30° C. and under an inert atmosphere for a period ranging from 15 to 24 h.

The object of the invention is also a method for preparing a compound of formula (IIc)

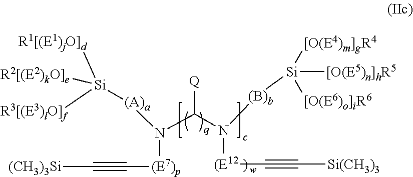

wherein:
E⁷ and E¹² are identical,
p and w are identical,
the definitions and preferred characteristics of R¹, R², R³, R⁴, R⁵, R⁶, E¹, E², E³, E⁴, E⁵, E⁶, E⁷, E¹², A, B, Q, a, b, c, d, e, f, g, h, i, j, k, l, m, n, o, p, q and w for the compound (I) according to the invention apply to the compounds of formula (IIc):
   by reaction between a compound of formula (XIII)

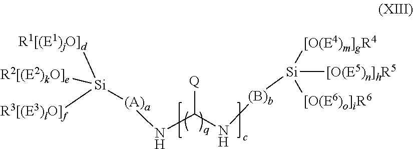

wherein the definitions and preferred characteristics of R¹, R², R³, R⁴, R⁵, R⁶, E¹, E², E³, E⁴, E⁵, E⁶, A, B, Q, a, b, c, d, e, f, g, h, i, j, k, l, m, n and o and q for the compound (I) according to the invention apply to the compounds of formula (XIII):
and a compound of formula (XIV)

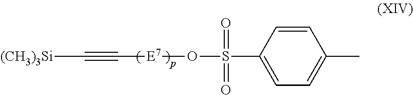

According to the invention, the reaction may be conducted between an equivalent of compound of formula (XIII) and (c+1) equivalents of compound of formula (XIV) in the presence of 2×(c+1) equivalents of potassium carbonate.

According to the invention, the definition of c is identical with the definition of c for the compound of formula (XIIII) and may thus represent 0, 1, 2 or 3.

According to the invention, the reaction between the compound of formula (XIII) and the compound of formula (XIV) occurs in a solution in the presence of potassium carbonate.

According to the invention, the content of a compound of formula (XIII) in the solution may range from 0.001 to 1 mol/L, preferably from 0.1 to 0.2 mol/L.

According to the invention, the reaction may be carried out in the presence of a solvent, preferably acetonitrile.

According to the invention, the reaction may be carried out at 85° C. and under an inert atmosphere for a period ranging from 15 to 24 h.

Another object of the present invention relates to a method for preparing a compound of formula (VI) comprising the hydrolysis of a compound of formula (XV)

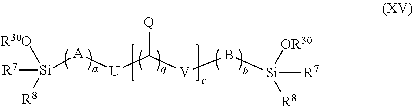

The whole of the characteristics or preferences for R⁷, R⁸, A, U, Q, V, B, a, b, c and q apply to the compound of formula (XV).

According to the invention, R³⁰ may represent a hydrogen atom, a C₁-C₆-alkyl group, an aryl group, a C₁-C₆-alkoxy group, a C₃-C₈-alkylene-alkenyl group.

According to the invention, the compound of formula (VI) of the siloxane type may be obtained according to a method (P1).

According to the invention, the method (P1) comprises the putting into solution of the compound of formula (XV) in the presence of water, a catalyst and optionally a surfactant.

According to the invention, the catalyst may be selected from an acid catalyst, a basic catalyst or a nucleophilic catalyst.

According to the invention, the surfactant may be selected from ammonium salts or phosphonium salts comprising at least one alkyl having at least 4 carbon atoms, block copolymers such as polyoxyethylene-polyoxypropylene or polyoxyethylene alkyl ethers. Preferably, the surfactant is hexadecyl trimethylammonium bromide (CTAB), Pluronic P123, Brij 58 or Brij 35.

According to the invention, the reaction may occur with or without an organic solvent.

According to the invention, the solvent may be selected from water, alcohols comprising from 1 to 8 carbon atoms, ethyl ether, THF, DMF or DMSO.

According to the invention, the alcohols comprising from 1 to 8 carbon atoms are selected from methanol, ethanol or propan-1-ol.

According to the invention, the reaction occurs at a temperature ranging from 20 to 100° C.

According to the invention, the reaction is conducted until a gel or a precipitate is obtained and then the final material is left to age for 2 to 7 days.

According to the invention, the compound of formula (VI) may also be obtained by a method (P2).

According to the invention, the method (P2) comprises the co-hydrolysis of the compound of formula (XV) with a silica source such as tetramethylorthosilicate (TMOS) or tetraethylorthosilicate (TEOS) or with another polysilylated organosilane, such as 1,4-bistrialkoxysilylethane (BTSE:alkoxy=methoxy or ethoxy) or 1,4-bistrialkoxysilylbenzene (BTSB:alkoxy=methoxy or ethoxy).

The characteristics of the solvent, the catalyst and of the temperature shown for the method (P1) apply to the method (P2).

According to the invention, the method (P2) may give the possibility of ending up with a siloxane-silica composite of the type (VI):xSiO₂ or a siloxane-silsesquioxane composite (SQ) such as a composite (VI):BTSE-SQ or a composite (VI):BTSB-SQ.

According to the invention, a composite (VI)-BTSE-SQ may be defined by the following formula:

O_{1.5}Si—(CH₂)₂—SiO_{1.5} VI:

wherein the oxygen atom of the terminal group SiO_{1/2} of the compound of formula (VI) is bound to an oxygen atom of the terminal group SiO_{1.5} of BTSE.

According to the invention, a composite (VI)-BTSB-SQ may be defined by the following formula:

O_{1.5}Si-Ph-SiO_{1.5} VI:

wherein the oxygen atom of the terminal group SiO_{1/2} of the compound of formula (VI) is bound to an oxygen atom of the terminal group SiO_{1.5} of BTSB.

According to the invention, the compound of formula (VI) may be obtained by a method (P3).

According to the invention, the method (P3) comprises co-hydrolysis of the compound of formula (XV) with a silicone source such as diethoxydimethylsilane.

The characteristics of the solvent, of the catalyst and of the temperature shown for the method (P1) apply to method (P3).

According to the invention, the method (P3) gives the possibility of ending up with a siloxane-silicone composite polymer of the type (VI); xMe₂SiO.

Another object of the present invention relates to a method for preparing a compound of formula (VII) comprising the hydrolysis of a compound of formula (XVI)

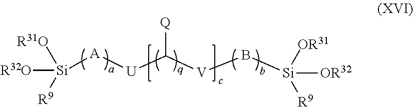

The whole of the characteristics or preferences for R⁹, A, U, Q, V, B, a, b, c and q apply to the compound of formula (XVI).

According to the invention, R³⁰ and R³¹, either identical or different, may represent a hydrogen atom, a C₁-C₆-alkyl group, an aryl group, a C₁-C₆-alkoxy group, a C₃-C₈-alkylene-alkenyl group.

According to the invention, the compound (VII) may be obtained by the method (P1) or (P2) applied to the compound (XVI).

According to the invention, the method (P2) may give the possibility of ending up with a siloxane-silica composite material of the type (VII); xSiO₂, and a silicone-silsesquioxane (SQ) such as a composite (VII):BTSE-SQ or a composite (VII):BTSB-SQ.

Another object of the present invention relates to a method for preparing a compound of formula (VIII) comprising the hydrolysis of a compound of formula (XVII)

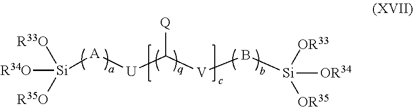

The whole of the characteristics or preferences for A, U, Q, V, B, a, b, c and q apply to the compound of formula (XVII).

According to the invention, R³³, R³⁴ and R³⁵, either identical or different, may represent a hydrogen atom, a C₁-C₆-alkyl group, an aryl group, a C₁-C₆-alkoxy group, a C₃-C₈-alkylene-alkenyl group.

According to the invention, the compound of formula (VIII) may be obtained by the method (P1) or (P2) applied to the compound of formula (XVII).

According to the invention, the method (P2) may give the possibility of ending up with a siloxane-silica composite material of the type (VIII); xSiO₂, and a silsesquioxane-silsesquioxane composite material (SQ) such as a composite (VIII):BTSE-SQ or a composite (VIII):BTSB-SQ.

The different aspects of the invention are illustrated by the examples which follow. These examples are given as an indication, without any limitation.

All the experiments were carried out by using standard Schlenk techniques under an inert atmosphere.

The liquid NMR spectra were obtained on Bruker apparatuses operating at 400 or 250 MHz, in dry CDCl₃ at 298 K.

The solid NMR spectra were measured on a Varian ASX 400 apparatus.

The ¹H and ¹³C and ²⁹Si chemical shifts are reported in ppm relatively to Me₄Si.

High resolution mass spectra were obtained by electrospray ionization.

The infrared spectra were obtained in ATR on a Perkin 100 spectrometer. The ATGs were obtained with a temperature gradient of 10° C./min.

The X-ray diffractograms were obtained at the Charles Coulomb Laboratory of Montpellier by using monochromatic CuKα radiation.

### EXAMPLE 1

### synthesis of prop-2-ynyl-bis-(3-triethoxysilyl-propyl)-amine

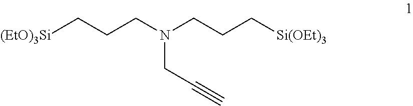

To a solution of bis(triethoxysilylpropyl)amine (12.8 g, 30.0 mmol) in THF containing 1,000 ppm of water (150 ml), calcium hydride (3.16 g, 75 mmol) and then propargyl bromide (80% in toluene, 4.28 g, 36.0 mmol) were added successively. The reaction medium was stirred for 16 h at room temperature. After evaporation of the solvents, extraction of the reaction mixture with pentane and concentration, a viscous yellow oil was obtained, and then purified by distillation under reduced pressure (130° C./2.10⁻² mbar) in order to obtain the compound 1 as a colorless oil (13.2 g, 28.4 mmol). Yield: 95%.

¹H NMR (250 MHz, CDCl₃) δ=3.81 (q, J=7.0 Hz, 12H), 3.38 (d, J=2.3 Hz, 2H), 2.56-2.34 (m, 4H), 2.13 (t, J=2.3 Hz, 1H), 1.65-1.46 (m, 4H), 1.21 (t, J=7.0 Hz, 18H), 0.66-0.56 (m, 4H). ¹³C NMR (101 MHz, CDCl₃) δ=79.0, 72.5, 58.4, 56.7, 41.8, 21.0, 18.4, 8.1. HRMS (ESI+):

m/z calculated for C₂₁H₄₆NO₆Si₂⁺: 464.2864;

m/z determined: 464.2871.

### EXAMPLE 2

### synthesis of N,N′-di-prop-2-ynyl-N,N′-bis-(3-triethoxysilyl-propyl)-ethane-1,2-diamine

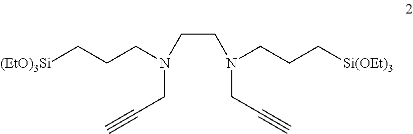

To a solution of N,N′-bis(3-triethoxysilylpropyl)ethane-1,2-diamine (4.41 g, 9.4 mmol) in THF containing 1,000 ppm of water (40 ml), calcium hydride (1.7 g, 37.5 mmol) and then propargyl bromide (80% in toluene, 3.49 g, 23.5 mmol) were added successively. The reaction mixture was stirred for 16 h at room temperature. After evaporation of the solvents, extraction of the reaction mixture with pentane and concentration, the compound 2 was obtained as a viscous oil (4.9 g, 9.0 mmol). Yield: 96%

¹H NMR (250 MHz, CDCl₃) δ=3.68 (q, J=7.0 Hz, 12H), 3.32 (d, J=2.2 Hz, 4H), 2.48 (s, 4H), 2.39-2.30 (m, 4H), 2.06 (t, J=2.3 Hz, 2H), 1.52-1.35 (m, 4H), 1.09 (t, J=7.0 Hz, 18H), 0.53-0.42 (m, 4H). ¹³C NMR (63 MHz, CDCl₃) δ=78.6, 72.7, 58.2, 57.0, 51.2, 41.9, 20.7, 18.2, 7.8.

HRMS (ESI+):

m/z calculated for C₂₆H₅₃N₂O₆Si₂⁺: 545.3442;

m/z determined: 545.3440.

### EXAMPLE 3

### synthesis of (3-azidopropyl)-bis-(3-triethoxysilyl-propyl)-amine

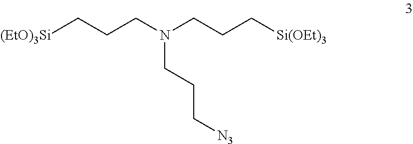

A mixture of bis(triethoxysilylpropyl)amine (1.0 g, 2.3 mmol), 3-azido-1-iodopropane (0.48 g, 2.3 mmol) and potassium carbonate (0.63 g, 4.6 mmol) in acetonitrile (HPLC grade, 20 ml) was stirred for 16 h at 85° C. in a sealed tube under nitrogen. The mixture was filtered, and then the filtrate was concentrated, in order to obtain the compound 3 as a yellowish oil (1.1 g, 2.2 mmol). Yield: 93%.

¹H NMR (250 MHz, CDCl₃) δ=3.80 (q, J=7.0 Hz, 12H), 3.31 (t, J=6.8 Hz, 2H), 2.46 (t, J=6.9 Hz, 2H), 2.38 (t, J=6.9 Hz, 4H), 1.75-1.61 (m, 2H), 1.59-1.41 (m, 4H), 1.21 (t, J=7.0 Hz, 18H), 0.61-0.49 (m, 4H). ¹³C NMR (63 MHz, CDCl₃) δ=58.5, 57.2, 51.1, 49.8, 26.9, 20.4, 18.4, 8.1.

HRMS (ESI+):

m/z calculated for C₂₁H₄₉N₄O₆Si₂: 509.3191;

m/z determined: 509.3174.

### EXAMPLE 4

### synthesis of N,N′-bis-(3-azidopropyl)-N,N′-bis-(3-triethoxysilyl-propyl)-ethane-1,2-diamine

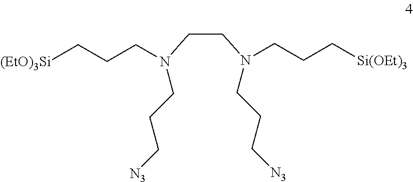

A mixture of N,N′-bis(triethoxysilylpropyl)ethane-1,2-diamine (0.9 g, 1.9 mmol), 3-azido-1-iodopropane (0.8 g, 3.8 mmol) and of potassium carbonate (1.1 g, 7.7 mmol) in acetonitrile (HPLC grade, 15 ml) was stirred for 16 h, at 85° C., in a sealed tube under nitrogen. The mixture was filtered, and then the filtrate was concentrated in order to obtain the compound 4 as a yellowish oil (0.99 g, 1.6 mmol).

Yield: 82%.

¹H NMR (250 MHz, CDCl₃) δ=3.80 (q, J=7.0 Hz, 12H), 3.31 (t, J=6.8 Hz, 4H), 2.54-2.46 (m, 8H), 2.38 (t, J=6.9 Hz, 4H), 1.75-1.61 (m, 4H), 1.59-1.41 (m, 4H), 1.21 (t, J=7.0 Hz, 18H), 0.61-0.49 (m, 4H). ¹³C NMR (63 MHz, CDCl₃) δ=58.4, 57.7, 52.6, 51.5, 49.7, 26.9, 20.5, 18.4, 8.0.

HRMS (ESI+):

m/z calculated for C₂₆H₅₉N₈O₆Si₂: 635.4096;

m/z determined: 635.4089.

### EXAMPLE 5

### synthesis of prop-2-ynyl-bis-(3-(diethoxy)(methyl)silyl-propyl)-amine

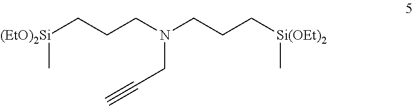

To a solution of bis(diethoxymethylsilylpropyl)amine (2.0 g, 4.9 mmol) in THF containing 1,000 ppm of water (20 ml), calcium hydride (0.6 g, 12.3 mmol) and then propargyl bromide (80% in toluene, 1.1 g, 7.4 mmol) were added successively. The reaction medium was stirred for 16 h, at room temperature. After evaporation of the solvents, extraction of the reaction mixture with pentane and concentration, the compound 5 was obtained as a viscous yellow oil (1.8 g, 4.6 mmol).

Yield: 93%.

¹H NMR (250 MHz, CDCl₃) δ=3.75 (q, J=7.0 Hz, 8H), 3.39 (d, J=2.3 Hz, 2H), 2.45 (t, J=7.5 Hz, 4H), 2.14 (t, J=2.3 Hz, 1H), 1.58-1.41 (m, 4H), 1.20 (t, J=7.0 Hz, 12H), 0.63-0.54 (m, 4H), 0.11 (s, 6H). ¹³C NMR (63 MHz, CDCl₃) δ=78.9, 72.6, 58.2, 56.9, 41.9, 21.0, 18.5, 11.5, −4.8.

HRMS (ESI+):

m/z calculated for C₁₉H₄₂NO₄Si₂: 404.2652;

m/z: determined, 404.2648.

### EXAMPLE 6

### synthesis of (3-trimethylsilyl-prop-2-ynyl)-bis-(3-triethoxysilyl-propyl)-amine

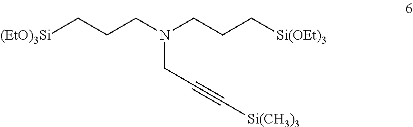

A mixture of bis(triethoxysilylpropyl)amine (1.0 g, 2.3 mmol), potassium carbonate (0.65 g, 4.7 mmol) and 3-(trimethylsilyl)prop-2-ynyl tosylate (0.66 g, 2.3 mmol) in acetonitrile (20 ml) was stirred for 15 hours at 85° C. in a sealed tube. After cooling to room temperature, the mixture was filtered and then the filtrate was concentrated in order to obtain the compound 6 as a yellow oil (1.2 g, 2.2 mmol). Yield: 94%.

¹H NMR (400 MHz, CDCl₃) δ=3.81 (q, J=7.0 Hz, 12H), 3.38 (s, 2H), 2.44 (t, J=8.0 Hz, 4H), 1.59-1.48 (m, 4H), 1.21 (t, J=7.0 Hz, 18H), 0.63-0.57 (m, 4H), 0.4 (s, 9H). ¹³C NMR (101 MHz, CDCl₃) δ=101.5, 89.2, 58.3, 56.7, 42.9, 20.8, 18.3, 8.0, 0.1.

HRMS (ESI+):

m/z calculated for C₂₄H₅₄NO₆Si₃: 536.3259;

m/z determined: 536.3242.

### EXAMPLE 7

### Synthesis of an Organosilicone Material with an Alkyne Function Obtained from the Compound 1

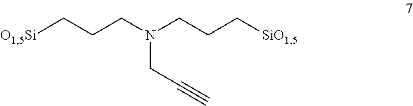

The synthesis was adapted from a method described in Corriu et al. (Corriu et al., Chem. Mater. 1992, 4 (6), 1217-1224).

For this, the compound 1 of Example 1 (0.8 g: 1.7 mmol) was dissolved in absolute ethanol (6.4 ml, 108 mmol). Under strong stirring, ammonium fluoride (0.64 ml, a 1 M solution in water, 0.64 mmol) is then added with distilled water (0.34 g, 19 mmol).

The final molar ratio was: compound 1/NH₄F/H₂O/EtOH:1/0.38/11/63.

After 1 minute with stirring, the mixture was left at rest for 4 days at room temperature. A gel was obtained. It was milled on a filtrating plate, dried, washed with water, ethanol and then acetone, and then dried under reduced pressure (0.1 mbar) in order to obtain a pale yellow powder.

Infrared (cm⁻¹): 880, 1025, 1390, 2820, 2888, 2930, 3290.

### EXAMPLE 8

### Synthesis of an Organosilicon Material Bearing Both Pyrene and Alkyne Functions Obtained from the Compound 1 by Nucleophilic Catalysis and a Click Reaction In Situ

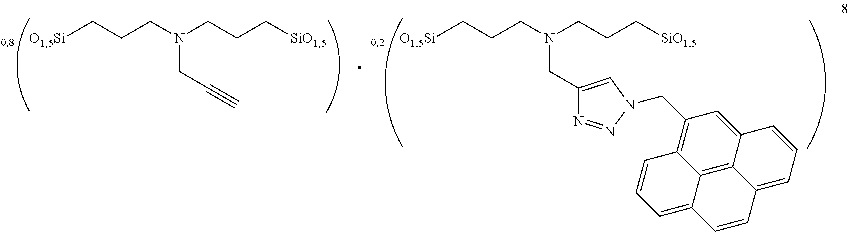

The compound 1 of example 1 (0.8 g: 1.7 mmol), azidomethylpyrene (0.1 g, 0.34 mmol) and sodium ascorbate (0.025 g, 0.13 mmol) were mixed in absolute ethanol (6.4 ml, 108 mmol). Under strong stirring, a mixture of ammonium fluoride (0.06 ml, 1 M solution in water, 0.06 mmol), distilled water (0.34 g, 19 mmol) and catalyst CuBr(PPh₃)₃ (0.06 g, 0.06 mmol) in THF (0.5 g, 6.9 mmol) was added.

The final molar ratio was: compound 1/NH₄F/H₂O/EtOH/azidomethylpyrene/ascorbate/Cu/THF=1:0.04:11:63:0.2:0.08:0.04:4. After 1 minute with stirring, the mixture was left for 3 days at room temperature. A gel was obtained. It was milled on a filtrating plate, dried, washed with water, ethanol and then acetone, and then dried in order to obtain a pale yellow powder.

Infrared (cm⁻¹): 849, 880, 1025, 1295, 1390, 1590, 1640, 2820, 2888, 2930, 2970, 3290.

### EXAMPLE 9

### Synthesis of a Mesostructured Organosilicon Material from Compound 1

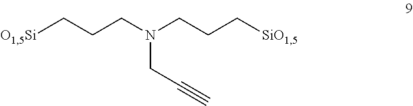

The synthesis was adapted from a method described in Nguyen et al. (Nguyen et al., J. Mater. Chem. 2010, 20 (19), 3910-3917).

A solution of sodium hexadecylsulfate (SHS, ABCR no. AB136610, 531 mg, 1.5 mmol), of 1 N HCl (4 mL, 4 mmol) in 36 ml of distilled water (2 mol) was brought to 60° C. The compound 1 of example 1 (0.72 g: 1.6 mmol) was then added.

The final molar ratio was: compound 1/HCl/SHS/H₂O:1/2.5/1/1250.

A precipitate appeared after 2 min. After 30 min with stirring at 60° C., the mixture was cooled, filtered, dried in the oven at 50° C. for 6 h and then under reduced pressure (0.1 mbar) at room temperature, for 15 h.

Elementary analysis of the material after synthesis is the following: H: 8.1%: C: 53%: N: 2.3%: S: 6.5%.

After 24 h of continuous extraction with the Soxhlet (10 ml of 37% HCl for 200 ml of EtOH) and then drying (50° C. at atmospheric pressure, 6 h, and then 20° C. under reduced pressure, 16 h), the material was obtained in the form of a white powder.

Elementary analysis after extraction: H: 4.7%: C: 28%: N: 3.5%: S: 0%

Infrared (cm⁻¹): 875, 1006, 1430, 2827, 2888, 2937, 2940, 3298.

NMR of the CPMAS solid:

²⁹Si (δ, ppm): −58.3 (T²): −67.0 (T³): condensation degree: 88%.

¹³C (δ, ppm): 79: 75: 56: 43: 21: 11

The presence of an IR band at 3298 cm⁻¹, as well as ¹³C signals at 79 ppm and 75 ppm confirm the presence of the alkyne function in the material of formula 9.

By X-ray diffraction applied to the thereby obtained material, a Bragg peak at 1.97 nm⁻¹ (repetition distance of 3.2 nm) is obtained.

This value allows confirmation that the material appears in a mesostructured form.

By thermogravimetric analysis applied to the thereby obtained material, the following was obtained:
a mass loss of 14% between 200 and 363° C.;
a mass loss of 28% between 365 and 700° C.;
a residue: 57% at 800° C.

These values allow confirmation of the thermal stability of the obtained material.

The scanning electron microscope images showed an aggregate of microfibers. In transmission electron microscopy, curved fibers with a length from 1 to 5 μm and a diameter from 70 to 150 nm and with longitudinal porosity were characterized.

### EXAMPLE 10

### synthesis of 2-azidoethyl)bis(triethoxysilyl-propyl)amine

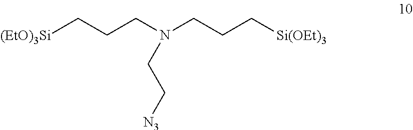

A mixture of 1-iodo-2-azidoethane (5.2 g, 30 mmol), bis-(triethoxysilylpropyl)amine (13 g, 30 mmol), potassium carbonate (8.2 g, 60 mmol) in 200 ml of acetonitrile were stirred in a sealed tube, under argon at 85° C., for 18 h. Next, the solvent was evaporated under reduced pressure, the product was extracted with pentane and then concentrated in vacuo in order to obtain the precursor 10.

¹H NMR: 3.80 (q, 12H): 3.25 (t, 2H): 2.65 (t, 2H): 2.45 (t, 4H): 1.55 (q, 4H): 1.20 (t, 18H): 0.60 (t, 4H).

¹³C NMR: 58.3: 57.3: 53.5: 49.5: 20.4: 18.2: 7.8.

HRMS ESI+:

m/z calculated for C₂₀H₄₇N₄O₆Si₂⁺: 495.3016,

m/z determined: 495.3034.

### EXAMPLE 11

### Synthesis of a Organosilicon Material with Nitride Functions Obtained by Nucleophilic Catalysis from the Precursor 10 of Example 10

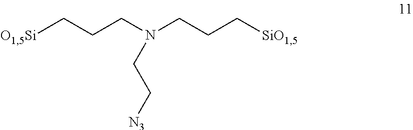

The precursor 10 (0.85 g: 1.7 mmol) was dissolved in absolute ethanol (6.4 ml, 108 mmol). With strong stirring, ammonium fluoride (0.32 ml, a 1M solution in water, 0.32 mmol) was then added with distilled water (0.34 g, 19 mmol). The final molar ratio was: compound 10/NH₄F/H₂O/EtOH:1/0.19/11/63.

After 1 minute with stirring, the mixture was left at rest for 2 days at room temperature. A gel was obtained. It was milled on a filtrating plate, dried, washed with water, with ethanol and then acetone, and then dried under reduced pressure (0.1 mbar) in order to obtain a white powder.

IR (cm⁻¹): 2937, 2880, 2819, 2097, 1468, 1407, 1346, 1275, 1093, 1006, 917, 743, 691

The presence of an IR band at 2097 cm⁻¹ confirms the presence of nitride functions in the material of formula 11.

### EXAMPLE 12

### Synthesis of an Organosilicon Material with Nitride and Ester Functions Obtained by Nucleophilic Catalysis and Click Reaction In Situ from the Precursor 10 of Example 10

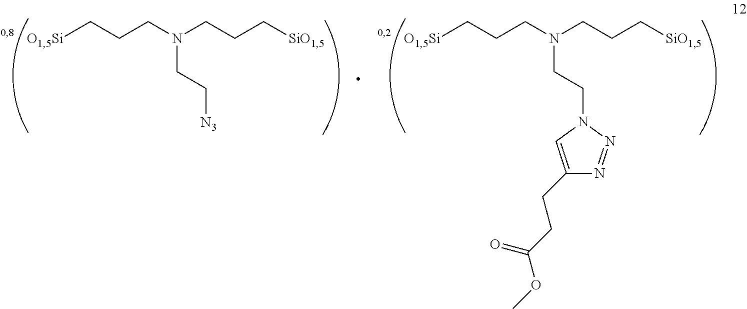

The precursor 10 (0.85 g: 1.7 mmol), methyl pentynoate (0.039 g, 0.34 mmol), and sodium ascorbate (0.025 g, 0.13 mmol) were mixed in absolute ethanol (6.4 mL, 108 mmol).

With strong stirring, a mixture of ammonium fluoride (0.32 mL, 1 M solution in water, 0.32 mmol) distilled water (0.34 g, 19 mmol), and catalyst CuBr(PPh₃)₃ (0.06 g, 0.06 mmol) in THF (0.5 g, 6.9 mmol) were added. The final molar ratio was: compound 10/NH₄F/H₂O/EtOH/methyl pentynoate/ascorbate/Cu/THF:1/0.19/11/63/0.2/0.08/0.04/4.

After 1 minute of stirring, the mixture was left for 2 days at room temperature. A gel was obtained. It was milled on a filtering plate, dried, washed with water, ethanol and then acetone, and the dried in order to obtain a pale grey powder.

IR (cm⁻¹): 2937, 2880, 2819, 2097, 1734, 1468, 1441, 1407, 1346, 1275, 1093, 1006, 917, 743, 691

The presence of an IR band at 2097 cm⁻¹ confirms the presence of nitride functions in the material of formula 12.

The presence of an IR band at 1734 cm⁻¹ confirms the presence of ester functions in the material of formula 12.

### EXAMPLE 13

### Synthesis of a Mesostructured Organosilicon Material from the Compound 10 of Example 10

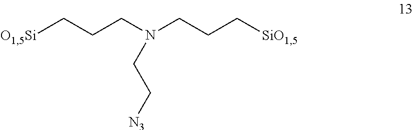

A solution of sodium hexadecylsulfate (SHS, ABCR cat. number AB136610, 531 mg, 1.5 mmol), of 1 N HCl (4 mL, 4 mmol) in 36 mL of distilled water (2 mol) a été portée à 60° C.

The precursor 10 (1.5 g:3 mmol) was then added. The final molar ratio was: compound 10/HCl/SHS/H₂O:1/1.25/0.5/625. A precipitate appeared after 2 mins. After 30 mins with stirring at 60° C., the mixture was cooled, filtered, dried in the oven at 50° C. for 6 h and the under reduced pressure (0.1 mbar) at room temperature for 15 h.

After 24 h of continuous extraction with the Soxhlet (10 mL of 37% HCl pour 200 mL of EtOH), the powder was stirred for one night in a solution (200 mL ethanol+12 mL 28% NH₄OH in water). The material was finally dried (50° C., 6 h and then under reduced pressure, 16 h), it was obtained as a white powder.

IR (cm⁻¹): 2937, 2880, 2819, 2097, 1468, 1407, 1346, 1275, 1093, 1006, 917, 743, 691.

### EXAMPLE 14

### Synthesis of an Organosilicon Material with Alkyne Functions from the Compound 2

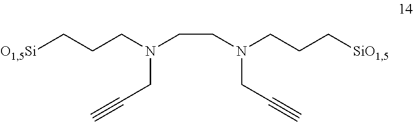

The compound 2 (0.16 mmol) was added with intense stirring to a mixture of CTAB (46 mg, 0.13 mmol), of distilled water (17.5 mL, 0.97 mol), of propan-1-ol (2 mL, 27 mmol) and of NH₄OH (25% by mass in NH₃, 0.5 mL, 6.5 mmol) heated beforehand to 50° C.

The composition of the mixture was compound 2/CTAB/propan-1-ol/NH₃/H₂O=1:0.78:197:40:4900

After 24 hours of stirring, the mixture was centrifuged and the precipitate was washed 3 times with ethanol and then extracted with the soxhlet with a solution of 5 mL of 12 M hydrochloric acid in 100 mL of ethanol with reflux for 48 hours.

The thereby obtained product was characterized in the following way:

IR (wavenumber in cm⁻¹): 917, 1018, 1093, 1259, 1322, 1433, 1465, 2819, 2930, 3290.

### EXAMPLE 15

### Synthesis of an Organosilicon Material with Alkyne Functions Obtained from the Compound 2 in the Presence of a Surfactant

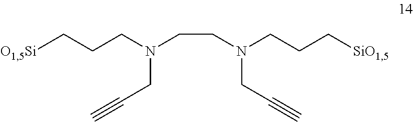

The compound 2 (1 mmol) was added with intense stirring to a mixture of hexadecyl trimethylammonium bromide (CTAB) (0.29 g, 0.8 mmol), of distilled water (17 mL, 0.97 mol) and NH₄OH (25% by mass, 2.3 mL, 30 mmol) heated to 70° C.

The composition of the mixture was: compound 2/CTAB/NH₃/H₂O=1:0.79:30:1500

After 24 hours of stirring, the water was evaporated in order to obtain the material (14). The surfactant was extracted by washing the powder with the soxhlet with a solution of 5 mL of 12 M hydrochloric acid in 100 mL of ethanol with reflux for 48 hours.

The thereby obtained product was characterized in the following way:

IR (wavenumber in cm⁻¹): 1018, 1093, 1259, 1322, 1433, 1465, 2819, 2930, 3290

### EXAMPLE 16

### Synthesis of an Organosilicon Material with Alkyne Function Obtained from the Compound 1 in the Presence of a Surfactant

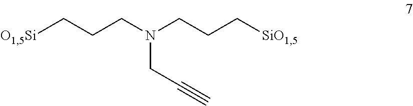

A mixture of hexadecyl trimethylammonium bromide (CTAB) (0.1 g, 0.28 mmol), of distilled water (35 mL, 2 mol), ammonium hydroxide (28%, 0.84 mL, 13 mmol) and propan-1-ol (4 mL, 53 mmol) was intensely stirred for 30 minutes a 50° C. Next, the compound (1) (0.2 mL, 0.4 mmol) was added and the mixture was stirred at 50° C. for 12 h.

The composition of the mixture was 1/CTAB/propan-1-ol/NH₄OH/eau=1:0.68:133:32:4660

After centrifugation (16500 rpm, 20 min), the material (7) was recovered and washed with water and ethanol and then dried under reduced pressure. The surfactant was extracted by washing the powder with the soxhlet with a solution of 5 mL of 12 M hydrochloric acid in 100 mL of ethanol with reflux for 48 hours.

The thereby obtained product was characterized in the following way:

IR (wavenumber in cm⁻¹): 744, 917, 1020, 1096, 1206, 1447, 2127 (alkyne), 2943, 3284.

Scanning electron microscope (SEM) images show that the material 7 is in the form of spherical nanoparticles, the diameter of which ranges from 100 to 180 nm.

Transmission electron microscope (TEM) images confirm that the material 7 is in the form of spherical nanoparticles, the diameter of which ranges from 100 to 180 nm.

The dynamic light scattering diagram (DLS) shows a very narrow distribution of the size of nanoparticles, of about 160 nm.

The nitrogen adsorption isotherm for analyzing the texture of the material 7 was obtained for:
a specific surface area according to the Brunauer, Emett and Teller (BET) method of 443.3018 m²/g
a specific surface area according to the Langmuir method of 641.2277 m²/g.

1. A compound of formula (I): 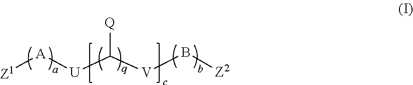
wherein:
Z¹ represents a group of formula 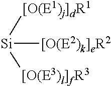
and Z² represents a group of formula 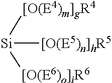
Z¹ and Z² simultaneously represent a group selected from the groups R⁷R⁸Si(OH), R⁹Si(OH)₂, Si(OH)₃, R⁷R⁸SiO_{1/2}, R⁹SiO or SiO_{3/2}:
U represents a group selected from the groups of formulae 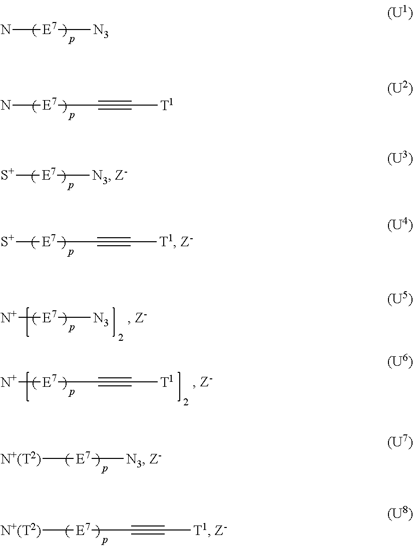
R¹, R², R³, R⁴, R⁵ and R⁶, either identical or different, represent a hydrogen atom, a C₁-C₆-alkyl group, an aryl group, a C₁-C₆-alkoxy group, a C₃-C₈-alkylene-alkenyl group:
E¹, E², E³, E⁴, E⁵ and E⁶, either identical or different, represent a C₁-C₆-alkylene group, C(O), C═CH₂, an imino-C₁-C₆-alkyl group, a group (C₁-C₆-alkyl)C═N—:
d, e, f, g, h, i, either identical or different, represent 0, 1, 2, 3, 4, 5, 6:
j, k, l, m, n, o, either identical or different, represent 0, 1, 2, 3:
R⁷, R⁸ and R⁹, either identical or different, represent a C₁-C₆-alkyl group, an aryl group, a C₃-C₈-alkylene-alkenyl group:
A, either identical or different, represents a group —CR¹⁰R¹¹ or a group selected from the groups of formulae 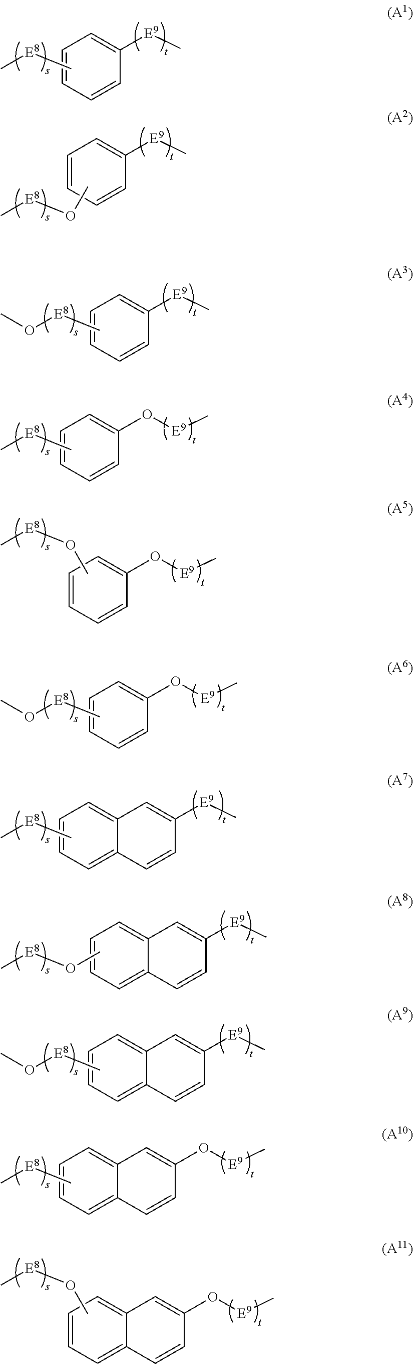 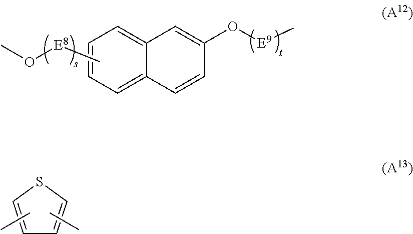
a represents 1, 2, 3, 4, 5, 6, 7, 8, 9, 10, 11 or 12:
B, either identical or different, represents a group —CR¹²R¹³ or a group selected from the groups of formulae 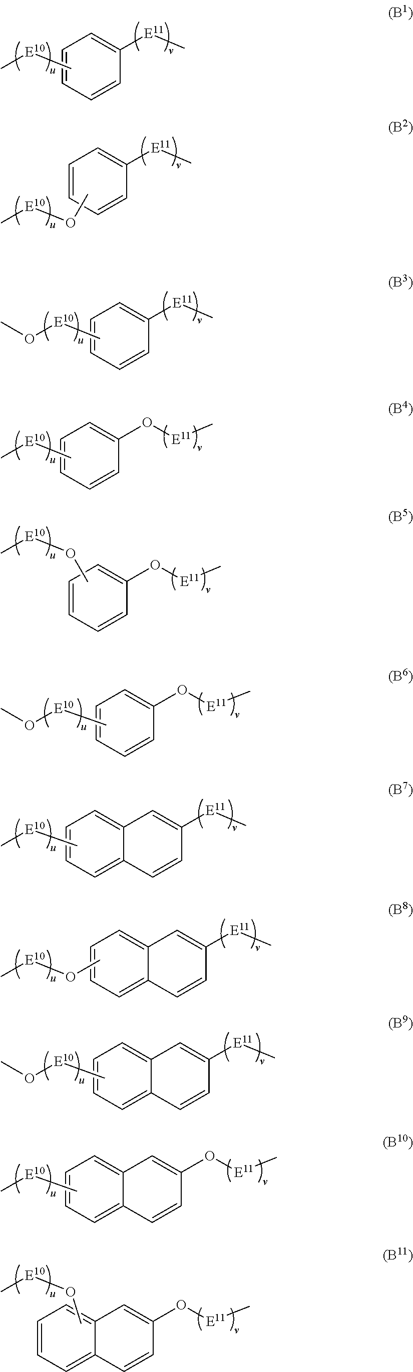 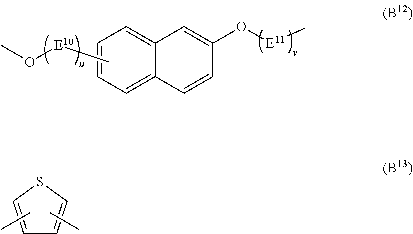
b represents 1, 2, 3, 4, 5, 6, 7, 8, 9, 10, 11 or 12:
V, either identical or different, represents independently a group selected from the groups of formulae 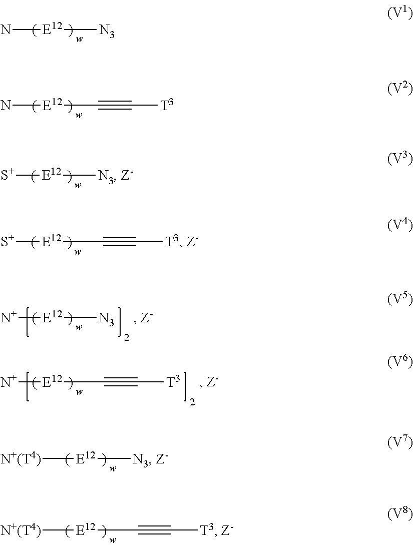
c represents 0, 1, 2 or 3:
Q, either identical or different, represents a hydrogen atom, a C₁-C₁₀ alkyl group, a C₁-C₁₀ alkoxy group, a C₃-C₁₀ cycloalkyl group, an aryl group: at least 2 groups Q and the carbon atoms to which they are bound form a carbocycle with 5, 6, 7, 8, 9 or 10 carbon atoms, substituted or non-substituted, aromatic or non-aromatic, saturated, partly or totally unsaturated, fused or non-fused:
q represents 0, 1, 2, 3, 4, 5, 6, 7, 8, 9, 10, 11 or 12:
E⁷, E⁸, E⁹, E¹⁰, E¹¹ and E¹² either identical or different, represent a group CR¹⁴R¹⁵, a group OCR¹⁶R¹⁷:
s, t, u and v, either identical or different, represent 0, 1, 2, 3, 4, 5, 6:
T¹ and T³, either identical or different, represent a hydrogen atom, a group —Si(R¹⁸)(R¹⁹)(R²⁰), a group —C(R²¹)(R²²)(OH):
T² and T⁴, either identical or different, represent a group (E¹³)ₓSi(R²³)(R²⁴)(R²⁵):
E¹³ represents a group —CR²⁶R²⁷:
R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶ and R²⁷, either identical or different, represent a hydrogen atom, a C₁-C₆-alkyl group, a C₁-C₆-alkoxy group, a C₃-C₈-alkylene-alkenyl group, an aryl group, an aryloxy group:
p, w and x, either identical or different, represent 1, 2, 3, 4, 5, 6, 7, 8, 9, 10, 11 or 12:
Z⁻ represents un anion selected from halides, BF₄⁻, B(Ph)₄⁻, CO₃²⁻, R²⁸CO₂⁻, R²⁹SO₃⁻, SO₄²⁻, PO₄³⁻, HPO₃²⁻, NO₃⁻;
R²⁸ represents a C₁-C₆-alkyl group or an aryl group:
R²⁹ represents a C₁-C₆-alkyl group, an aryl group or a group —CF₃:
as well as an enantiomer, an isomer or a diastereoisomer of this compound.

2. The compound according to claim 1 of formula (II): 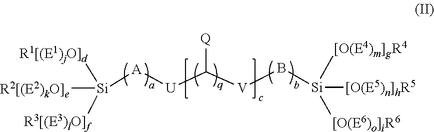
wherein R¹, R², R³, R⁴, R⁵, R⁶, E¹, E², E³, E⁴, E⁵, E⁶, A, U, Q, V, B, a, b, c, d, e, f, g, h, i, j, k, l, m, n, o and q are as defined in claim 1.

3. The compound according to claim 1 of formulae (IIa), (IIb) or (IIc): 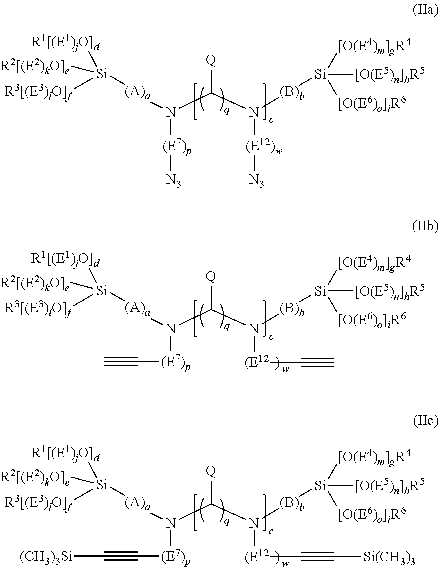
wherein R¹, R², R³, R⁴, R⁵, R⁶, E¹, E², E³, E⁴, E⁵, E⁶, E⁷, E¹², A, B, Q, a, b, c, d, e, f, g, h, j, k, l, m, n, o, p, q and w are as defined in claim 1.

4. The compound according to claim 1 of formulae (IId) or (IIe): 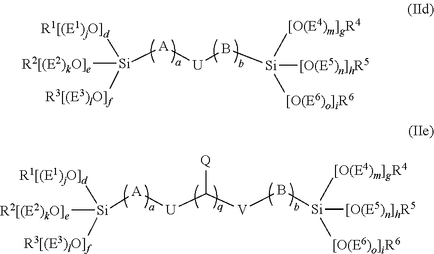
wherein R¹, R², R³, R⁴, R⁵, R⁶, E¹, E², E³, E⁴, E⁵, e, A, B, Q, U, V, a, b, d, e, f, g, h, i, j, k, l, m, n, o and q are as defined in claim 1.

5. The compound according to claim 1 of formulae (IIf), (IIg), (IIh), (IIi), (IIj) or (IIk): 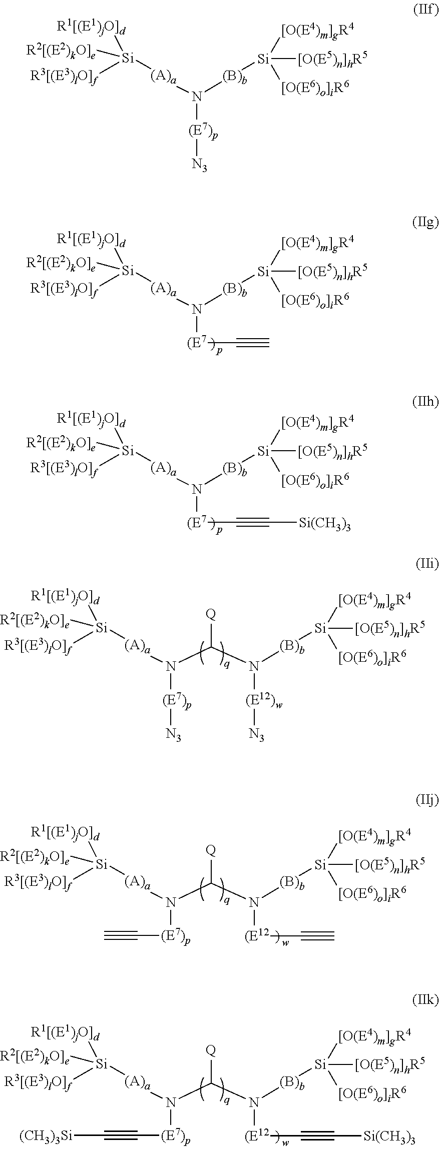
wherein R¹, R², R³, R⁴, R⁵, R⁶, E¹, E², E³, E⁴, E⁵, E⁶, E⁷, E¹², A, B, Q, a, c, d, e, f, g, h, i j, k, l, m, n, o, p, q and w are as defined in claim 1.

6. The compound according to claim 1 of formulae (III), (IV) or (V): 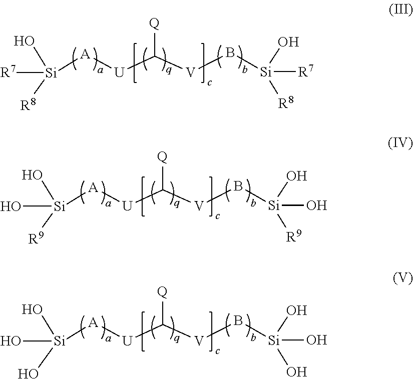
wherein R⁷, R⁸, R⁹, A, U, Q, V, B, a, b, c and q are as defined in claim 1.

7. A compound of formulae (VI), (VII) or (VIII), respectively obtained by polycondensation of a compound of formula (III), (IV) or (V) according to claim 6: 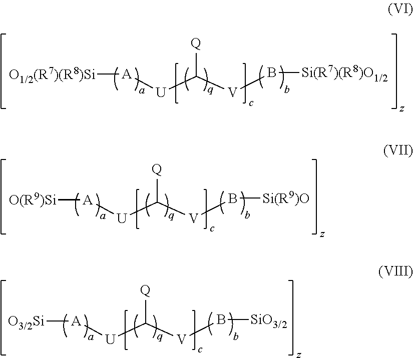
wherein:
R⁷, R⁸, R⁹, A, U, Q, V, B, a, b, c and q are as defined in claim 1:
z represents an integer ranging from 2 to 2,000,000.

8. The compound according to claim 1, wherein:
A and B represent a group —(CH₂)—: or
Q represents a hydrogen atom: or
R¹, R², R³, R⁴, R⁵ and R⁶ represent independently a methyl or ethyl group; or
a represents 1, 2 or 3: or
b represents 1, 2 or 3: or
q represents 0, 1, 2, 3 or 4: or
d, e, f, g, h and i, either identical or different, represent 0 or 1: or
j, k, l, m, n and o represent 0: or
R⁷ represents a methyl, ethyl, phenyl group: or
R⁸ represents a methyl, ethyl, phenyl group: or
R⁹ represents a methyl, ethyl, phenyl group: or
R²⁸ represents a methyl group or a phenyl group; or
R²⁹ represents a methyl group, a phenyl group or a group —CF₃.

9. The compound according to claim 1, wherein:
A and B represent a group —(CH₂)—:
Q represents a hydrogen atom:
R¹, R², R³, R⁴, R⁵ and R⁶ represent independently a methyl or ethyl group;
a represents 1, 2 or 3:
b represents 1, 2 or 3:
q represents 0, 1, 2, 3 or 4:
d, e, f, g, h and i, either identical or different, represent 0 or 1:
j, k, l, m, n and o represent 0.
R²⁸ represents a methyl group or a phenyl group;
R²⁹ represents a methyl group, a phenyl group or a group —CF₃.

10. The compound according to claim 6, wherein:
A and B represent un group —(CH₂)—:
Q represents a hydrogen atom:
a represents 3, 4, 5, or 6:
b represents 3, 4, 5 or 6:
q represents 0, 1, 2, 3 or 4:
d, e, f, g, h and i, either identical or different, represent 0 or 1:
j, k, l, m, n and o represent 0:
R⁷ represents a methyl, ethyl, phenyl group:
R⁸ represents a methyl, ethyl, phenyl group:
R⁹ represents a methyl, ethyl, phenyl group.
